(19) United States
(12) Patent Application Publication
(10) Pub. No.: US 2011/0111337 A1
(43) Pub. Date: May 12, 2011

(54) MAGNETIC CARRIER

(75) Inventors: Juun Horie, Tokyo (JP); Kenta Kubo, Kamakura-shi (JP); Tomoaki Miyazawa, Tokyo (JP); Takeshi Yamamoto, Yokohama-shi (JP); Manami Haraguchi, Yokohama-shi (JP); Hirokazu Usami, Kawasaki-shi (JP); Yoshinobu Baba, Yokohama-shi (JP); Koh Ishigami, Mishima-shi (JP); Hitoshi Oda, Sagamihara-shi (JP)

(73) Assignee: CANON KABUSHIKI KAISHA, Tokyo (JP)

(21) Appl. No.: 12/939,086

(22) Filed: Nov. 3, 2010

(30) Foreign Application Priority Data
Nov. 9, 2009 (JP) 2009-256236

(51) Int. Cl. G03G 9/083

(52) U.S. Cl. 430/106.2

(57) ABSTRACT

In the formation of images by a two-component development system, provided is a magnetic carrier that can be used to output an image which has sufficient density, in which few white spots are present in a low-density portion located near the boundary between a high-density region and a low-density region, and in which the low-density portion has good graininess. The magnetic carrier contains magnetic carrier particles each of which has resin and a magnetic particle. The magnetic particle contains ferrite phases and phases comprising a perovskite-structured compound. The ferrite phases and phases comprising a perovskite-structured compound are combined.

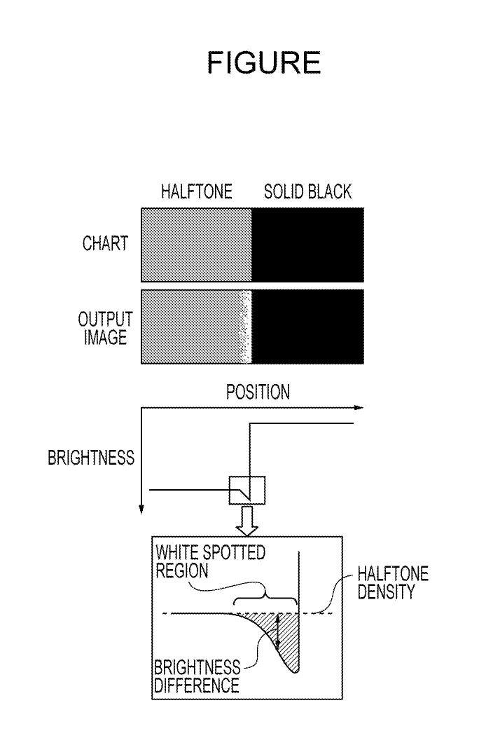

### BACKGROUND OF THE INVENTION

1. Field of the Invention

The present invention relates to a magnetic carrier for use in two-component developers used for copiers, printers, and similar machines using two-component development systems.

2. Description of the Related Art

In recent years, digital full-color electrophotographic printers have been widely used, have been required to have a high printing speed, and have been required to output high-quality images and developers have been required to have a long lifetime. Under these circumstances, development processes have required techniques useful in outputting high-quality images under severe conditions for development. Therefore, the development of magnetic carriers with better developability has been desired.

Since the resistance of a magnetic carrier significantly affects the developability thereof, attempts have been made to improve the developability of magnetic carriers by adjusting the resistance thereof.

The following technique has been proposed: a technique in which development properties of a magnetic carrier are improved by providing a dielectric material on a portion of the magnetic carrier with the resistance of the magnetic carrier maintained relatively high, graininess is prevented from being deteriorated by the injection of charges during development, and desired image density is secured. For example, Japanese Patent Laid-Open Nos. 60-19157 and 10-83120 disclose that a developer with high reproducibility in high image density and halftone can be provided in such a manner that a two-component magnetic carrier is coated with a high-resistance material containing a high-dielectric constant substance such that the resistance of the two-component magnetic carrier is maintained high.

Japanese Patent Laid-Open No. 2007-102052 discloses a technique in which an image stable in density over a long period of time is obtained using a magnetic material-dispersed resin carrier containing a binder resin and magnetic particles dispersed therein. The resistance of the magnetic material-dispersed resin carrier is maintained high because a high-resistance substance with a dielectric constant of 80 or more is dispersed in the binder resin.

The following technique has been proposed: a technique in which the developability of magnetic carrier is enhanced by increasing the effective dielectric constant thereof without providing a dielectric material on a portion of the magnetic carrier in such a manner that a conducting path in a magnetic carrier is controlled under the application of an electric field. Japanese Patent Laid-Open No. 2008-287243 discloses that the dependence of the dielectric constant of a magnetic carrier on an electric field can be controlled using a resin-filled ferrite magnetic carrier containing porous ferrite particles having pores filled with resin. This allows the dielectric constant of the magnetic carrier to be increased under development bias. Therefore, the following method can be provided: a method of forming an image with good developability even on a photosensitive member, such as an amorphous silicon photosensitive member, having low surface resistance, with the injection of charges during development being prevented.

Japanese Patent Laid-Open No. 2007-218955 discloses that a resin-filled ferrite magnetic carrier has a problem that the resistance of the magnetic carrier cannot be maintained high during the application of an electric field and also discloses that a magnetic core having a magnetic phase which is ferrite and a non-magnetic phase containing at least one of SiO₂, Al₂O₃, and Al(OH)₃ is used to increase the resistance of the magnetic carrier.

For a technique in which a dielectric material is dispersed in a coating material with high resistance as disclosed in as disclosed in Japanese Patent Laid-Open Nos. 60-19157 and 10-83120, a good image which has high density and good graininess, that is, reduced graininess in a newly printed state is obtained; however, so-called “white spots” are caused because the density of a low-density portion is reduced near the boundary between the low-density portion and a high-density portion. The continuation of printing for a certain time or more causes conspicuous white spots. This is probably because the charge of a toner is insufficient to electrically charge an electrostatic latent image, an electric field is distorted near the boundary between the low-density portion and the high-density portion, and the developability of the magnetic carrier is insufficient. Although an image has relatively good density and graininess in a newly printed state, the density and graininess of the image are reduced during long-term use. The reduction in density of the image during long-term use is probably caused by the fact that the wear of a coating layer reduces the effect of the dielectric material to cause a reduction in developability. The reduction in graininess of the image during long-term use is probably caused by the fact that the wear of the coating layer, which has high resistance, reduces the resistance of the magnetic carrier and therefore a charge is injected into the electrostatic latent image.

A method of producing a magnetic carrier by dispersing a magnetic material and a dielectric material in a binder resin as disclosed in Japanese Patent Laid-Open No. 2007-102052 provides an image which has relatively good density and quality in a newly printed state and is, however, ineffective in solving a problem on white spots because of insufficient developability. If the amount of the dielectric material dispersed in the binder resin is increased for the purpose of solving the problem on the white spots, the amount of the magnetic material dispersed therein needs to be reduced in relation to the composition of the magnetic carrier. This reduces magnetic properties of the magnetic carrier to cause a phenomenon that the transferability of a developer is reduced or portions of the magnetic carrier adhere to a photosensitive member. The increase in magnetic susceptibility of magnetic particles dispersed in the binder resin reduces the resistance of the magnetic particles; hence, it is difficult to maintain the resistance of the magnetic carrier high.

The resin-filled magnetic carrier, which contains the porous ferrite particles, disclosed in Japanese Patent Laid-Open No. 2008-287243 can be prevented from being reduced in resistance under a high electric field and also can be increased in dielectric constant. The increase in dielectric constant of the magnetic carrier during the application of an electric field is probably due to the increase in the number of conducting paths in the porous ferrite particles; hence, it is difficult to independently control relations between resistance properties and dielectric properties of the magnetic carrier. Therefore, an increase in dielectric constant of the magnetic carrier causes the injection of charges during development because of a reduction in resistance and therefore causes a reduction in graininess.

The use of the magnetic core, which has the magnetic phase which is ferrite and the non-magnetic phase, disclosed in Japanese Patent Laid-Open No. 2007-218955 allows the ability of the magnetic carrier to maintain its resistance high to be enhanced and also allows the quality of an image to be prevented from being reduced due to the injection of charges during development. However, a problem on developability due to an increase in resistance of the magnetic carrier remains unsolved. Therefore, although an image with reduced graininess can be obtained, problems on image density and white spots still remain.

The conventionally proposed methods can output images which have sufficient density and relatively high quality in a newly printed state and cannot, however, output images which are improved in white spot in a newly printed state or images which are sufficiently stable during long-term use.

### SUMMARY OF THE INVENTION

The present invention provides a magnetic carrier that can be used to stably output a high-quality image which has sufficient density, few white spots, and good graininess over a long period of time.

The present invention relates to a magnetic carrier containing magnetic carrier particles each of which has at least a magnetic particle and resin. The magnetic particle contains ferrite phases and phases comprising a perovskite-structured compound. The ferrite phases and phases comprising a perovskite-structured compound are combined.

Further features of the present invention will become apparent from the following description of exemplary embodiments with reference to the attached drawing.

### BRIEF DESCRIPTION OF THE DRAWING

The FIGURE is an illustration showing a method of evaluating white spots.

### DESCRIPTION OF THE EMBODIMENTS

We have focused on improving the developability of magnetic carriers and have performed intensive studies. As a result, we have found that a carrier having high resistance and good developability can be obtained using a magnetic particle containing ferrite phases (first phases) and phases (second phases) comprising a perovskite-structured compound, the ferrite phases and the phases comprising the perovskite-structured compound being combined, as a magnetic material for carriers. This enables a high-quality image which has few white spots, good graininess, and desired density over a long period of time to be stably output.

The present invention will now be described in detail.

A ferrite constituting ferrite phases present in a magnetic particle contained in a magnetic carrier particle is a sintered body represented by the following formula:

(M1₂O)ₓ(M2O)_{y}(Fe₂O₃)_{z}

wherein M1 is a monovalent metal, M2 is a bivalent metal, x+y+z=1.0, 0≦0.8, 0≦y≦0.8, and 0.2<z<1.0.

In the formula, M1 and M2 are preferably at least one selected from the group consisting of Li, Fe, Mn, Mg, Sr, Cu, Zn, Ni, Co, and Ca.

Examples of the ferrite include magnetic Li ferrites, Mn ferrites, Mn—Mg ferrites, Mn—Mg—Sr ferrites, and Cu—Zn ferrites. The Li ferrites are represented by, for example, the formula (Li₂O)ₐ(Fe₂O₃)_{b}, wherein 0.0<a<0.4, 0.6≦b<1.0, and a+b=1 or the formula (Li₂O)ₐ(SrO)_{b}(Fe₂O₃)_{c}, wherein 0.0<a<0.4, 0.0<b<0.2, 0.4≦c<1.0, and a+b=1. The Mn ferrites are represented by, for example, the formula (MnO)ₐ(Fe₂O₃)_{b}, wherein 0.0<a<0.5, 0.5≦b<1.0, and a+b=1. The Mn—Mg ferrites are represented by, for example, the formula (MnO)ₐ(MgO)_{b}(Fe₂O₃)_{c}, wherein 0.0<a<0.5, 0.0<b<0.5, 0.5≦c<1.0, and a+b+c=1. The Mn—Mg—Sr ferrites are represented by, for example, the formula (MnO)ₐ (MgO)_{b}(SrO)_{c}(Fe₂O₃)_{d}, wherein 0.0<a<0.5, 0.0<b<0.5, 0.0<c<0.5, 0.5≦d<1.0, and a+b+c+d=1. The Cu—Zn ferrites are represented by, for example, the formula (CuO)ₐ(ZnO)_{b}(Fe₂O₃)_{c}, wherein 0.0<a<0.5, 0.0<b<0.5, 0.5≦c<1.0, and a+b+c=1. The ferrite may contain a slight amount of another metal.

In view of the ease of controlling the growth rate of crystals, the ferrite is preferably a Mn ferrite, Mn—Mg ferrite, or Mn—Mg—Sr ferrite, which contains Mg.

A perovskite-structured compound contained in a magnetic particle contained in the magnetic carrier is a sintered body represented by the following formula:

AXO₃

wherein A is a bivalent metal which is at least one selected from the group consisting of Ba, Ca, and Sr and X is a tetravalent metal which is at least one selected from the group consisting of Ti, Nb, Fe, Co, Ni, and Cr.

In particular, the perovskite-structured compound is preferably SrTiO₃, BaTiO₃, or CaTiO₃, which has an extremely large dielectric constant at room temperature. SrTiO₃, BaTiO₃, or CaTiO₃ used may be a conventionally known SrTiO₃ powder, BaTiO₃ powder, or CaTiO₃ powder, respectively.

The SrTiO₃ powder, the BaTiO₃ powder, or the CaTiO₃ powder may be a commercially available one. The SrTiO₃ powder may be HPST-1 available from Fuji Titanium Industry Co., Ltd., HPST-2 available from Fuji Titanium Industry Co., Ltd., HST available from Fuji Titanium Industry Co., Ltd., ST available from Sakai Chemical Industry Co., Ltd., or ST available from KCM Corporation. The BaTiO₃ powder may be HBT available from Fuji Titanium Industry Co., Ltd., BT-100 available from Fuji Titanium Industry Co., Ltd., BT available from Sakai Chemical Industry Co., Ltd., or BT available from KCM Corporation. The CaTiO₃ powder may be, for example, CT available from KCM Corporation.

In the present invention, the ferrite phases and phases comprising the perovskite-structured compound are combined. The term “combined” as used herein means a state that both phases are not only in contact with each other but also portions of the phases abut against each other at the interfaces therebetween or are bonded to each other and particularly means, for example, a state that particles in a sintered body abut against each other.

The magnetic particle, which is contained in the magnetic carrier particle, is preferably porous. When the magnetic material is porous, the electrical resistance of the magnetic material can be optimally controlled.

A method of producing the magnetic carrier according to the present invention will now be described in detail.

### Step 1: Preparation of Pulverized Pre-Calcined Ferrite

### Substep 1-1: Weighing and Mixing

Raw materials of the ferrite are weighed and are then mixed together.

Examples of the ferrite raw materials include particles of metals selected from the group consisting of Li, Fe, Mn, Mg, Sr, Cu, Zn, Ni, Co, and Ca; oxides of these metals; hydroxides of these metals; oxalates of these metals; and carbonates of these metals.

Examples of a machine for mixing the ferrite raw materials include ball mills, planetary mills, and Giotto mills. In order to prepare slurry with a solid content of 60% to 80% by weight by dispersing the ferrite raw materials in water, a wet ball mill is preferably used because the wet ball mill has good mixing performance and is suitable for forming a porous structure.

### Substep 1-2: Pre-Calcination

The mixed ferrite raw materials are granulated into pieces with a spray dryer. After being dried, the pieces are pre-calcined at a temperature of 700° C. to 1,000° C. for 0.5 hour to 5.0 hours in air, whereby the ferrite is prepared. The pre-calcining temperature of the pieces is preferably 1,000° C. or lower because when the pre-calcining temperature thereof is higher than 1,000° C., the pieces are sintered and therefore the ferrite is unlikely to be pulverized into particles with a size suitable for porous bodies.

### Substep 1-3: Pulverization

The pre-calcined ferrite prepared in Substep 1-2 is pulverized with a pulverizer. Examples of the pulverizer include crashers, hammer mills, ball mills, bead mills, planetary mills, and Giotto mills. The pulverized pre-calcined ferrite preferably has a volume-based 50% (D50) particle size of 0.5 μm to 5.0 μm.

In order to allow the pulverized pre-calcined ferrite to have the above particle size, a material for forming balls used in a ball mill or a material for forming beads used in a bead mill is preferably appropriately selected and/or the operating time of the ball or bead mill is preferably controlled. In particular, in order to allow the pulverized pre-calcined ferrite to have a reduced particle size, high density balls are preferably used and the pulverizing time of the pre-calcined ferrite is preferably long. The material for forming the balls or the beads is not particularly limited and is preferably one capable of achieving a desired particle size. In order to achieve a broad particle size distribution, a mixture of powders having different particle sizes may be used.

Examples of the material for forming the balls or the beads include glass products such as soda glass, which has a density of 2.5 g/cm³, soda-free glass, which has a density of 2.6 g/cm³, and high-density glass, which has a density of 2.7 g/cm³; quartz, which has a density of 2.2 g/cm³; titania, which has a density of 3.9 g/cm³; silicon nitride, which has a density of 3.2 g/cm³; alumina, which has a density of 3.6 g/cm³; zirconia, which has a density of 6.0 g/cm³; steel, which has a density of 7.9 g/cm³; and stainless steel, which has a density of 8.0 g/cm³. In particular, alumina, zirconia, and stainless steel have good wear resistance and therefore are preferred.

The balls or the beads are not particularly limited in diameter and preferably have a diameter suitable for obtaining powder with a desired particle size. The balls preferably have a diameter of 5 mm to 20 mm. The beads preferably have a diameter of 0.1 mm to less than 5 mm.

A wet ball or bead mill using water or slurry is more preferred than a dry ball or bead mill because the wet ball or bead mill has high pulverizing efficiency and is readily controllable.

### Step 2: Preparation of Magnetic Material

### Substep 2-1: Granulation

The pulverized pre-calcined ferrite prepared in Step 1 and the perovskite-structured compound are weighed.

The perovskite-structured compound is preferably used in the form of powder with a volume-based 50% (D50) particle size of 0.5 μm to 5.0 μm.

In view of the polarization effect and magnetic properties of the magnetic carrier, the ratio of the perovskite-structured compound to the pulverized pre-calcined ferrite is preferably five to 100 parts by mass and more preferably 40 to 100 parts by mass.

The pulverized pre-calcined ferrite is mixed with water, a binder, and the perovskite-structured compound, whereby a ferrite slurry is prepared. A pore adjuster such as a foaming agent, a fine organic powder, or Na₂CO₃ is added to the ferrite slurry as required. The binder is preferably, for example, polyvinyl alcohol.

In the case of wet-pulverizing the pre-calcined ferrite in Substep 1-3, the binder and the pore adjuster, as required, are preferably added to the ferrite slurry in consideration of water in the ferrite slurry. In order to control porosity, the solid content of the ferrite slurry is preferably adjusted to 50% to 80% by weight in advance of granulation.

The ferrite slurry is formed into granules with a spray drier in an atmosphere heated at a temperature of 100° C. to 200° C. The granules are dried in the atmosphere.

The spray drier can desirably control the size of a porous magnetic particle and therefore is preferably used. The size of the porous magnetic particle can be controlled by selecting the rotational speed of a disk used in the spray drier or the discharge rate of the ferrite slurry.

### Substep 2-2: Calcination

The granules are calcined at a temperature of 800° C. to 1,400° C. for one hour to 24 hours.

An increase in calcination temperature and an increase in calcination time promote the calcination of the porous magnetic particle to reduce the pore size and pore volume of the porous magnetic particle. The resistance of the ferrite phase can be reduced by controlling an atmosphere for calcining the granules or by calcining the granules in a reducing atmosphere.

### Substep 2-3: Separation

After the calcined granules are broken, coarse granules and fine granules are preferably removed from the resulting granules by classification or sieving. Furthermore, feebly magnetic granules are preferably removed from the resulting granules.

### Step 3: Preparation of Magnetic Carrier

### Substep 3-1: Filling

When magnetic particles prepared in Step 2 have pores and therefore are porous, the pores of the magnetic particles are preferably filled with resin for the purpose of obtaining mechanical strength and resistance appropriate to the magnetic carrier.

A process of filling the pores of the magnetic particles with the resin is not particularly limited and is preferably one in which a resin solution prepared by mixing the resin and a solvent is filled in the pores of the magnetic particles.

The content of the resin in the resin solution is preferably 1% to 30% by mass and more preferably 2% to 20% by mass. When the resin content of the resin solution is 30% by mass or less, the viscosity of the resin solution is not high and therefore the resin solution is likely to be uniformly filled in the pores of the magnetic particles. When the resin content thereof is 1% by mass or more, the vaporization rate of the solvent is not low and therefore the resin solution can be uniformly filled in the pores of the magnetic particles.

The resin filled in the pores of the magnetic particles is not particularly limited and may be a thermoplastic or thermosetting resin, which preferably has high affinity to the magnetic particles. When the resin has high affinity to the magnetic particles, the magnetic particles can be readily coated with the resin when the pores of the magnetic particles are filled with the resin.

Examples of the thermoplastic resin include polystyrenes, styrene acrylic resins, styrene methacrylic resins, styrene-butadiene copolymers, ethylene-vinyl acetate copolymers, polyvinyl chlorides, polyvinyl acetates, polyvinylidene fluorides, fluorocarbon resins, perfluorocarbon resins, polyvinyl pyrrolidones, petroleum resins, novolak resins, saturated alkyl polyester resins, polyethylene terephthalate, polybutylene terephthalate, polyarylates, polyamide resins, polyacetal resins, polycarbonate resins, polyether sulfone resins, polysulfone resins, polyphenylene sulfide resins, and polyether ketone resins.

Examples of the thermosetting resin include phenolic resins, modified phenolic resins, maleic resins, alkyd resins, epoxy resins, unsaturated polyesters obtained by the polycondensation of maleic anhydride and terephthalic acid with a polyol, urea resins, melamine resins, urea-melamine resins, xylene resins, toluene resins, guanamine resins, melamine-guanamine resins, acetoguanamine resins, glyptal resins, furan resins, silicone resins, modified silicone resins, polyimide resins, polyamide-imide resins, polyether-imide resins, and polyurethane resins.

Resins obtained by modifying these resins may be used. In particular, the following resins have high affinity to ferrite particles and therefore are preferred: fluorine-containing resins such as polyvinylidene fluoride resins, fluorocarbon resins, perfluorocarbon resins, and solvent-soluble perfluorocarbon resins; modified silicone resins; and silicone resins.

In particular, a silicone resin is preferred. The silicone resin may be conventional one.

Examples of commercially available silicone resins include silicone resins KR 271, KR 255, and KR 152 available from Shin-Etsu Chemical Co., Ltd.; silicone resins SR 2400, SR 2405, SR 2410, and SR 2411 available from Dow Corning Toray Co., Ltd.; modified silicone resins KR 206 (alkyd-modified), KR 5208 (acryl-modified), ES 1001N (epoxy-modified), and KR 305 (urethane-modified) available from Shin-Etsu Chemical Co., Ltd; and modified silicone resins SR 2115 (epoxy-modified) and SR 2110 (alkyd-modified) available from Dow Corning Toray Silicone Co., Ltd.

A silane-coupling agent serving as a charge control agent may be added to the silicone resin. The amount of the silane-coupling agent added to the silicone resin is preferably one to 50 parts by mass per 100 parts by mass of the silicone resin.

Examples of the silane-coupling agent include γ-aminopropyltrimethoxysilane, γ-aminopropylmethoxydiethoxysilane, γ-aminopropyltriethoxysilane, N-β-(aminoethyl)-γ-aminopropyltrimethoxysilane, N-β-(aminoethyl)-γ-aminopropylmethyldimethoxysilane, N-phenyl-γ-aminopropyltrimethoxysilane, hexamethyldisilazane, methyltrimethoxysilane, buthyltrimethoxysilane, isobuthyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, and p-methylphenyltrimethoxysilane.

A process of filling the resin in the pores of the magnetic particles is as follows: the resin is diluted with a solvent and is then filled in the pores of the magnetic particles. The solvent used may be one capable of dissolving the resin. When the resin is soluble in organic solvents, examples of an organic solvent used herein include toluene, xylene, cellosolve butyl acetate, methyl ethyl ketone, methyl isobutyl ketone, and methanol. When the resin is soluble in water or is of an emulsion type, the solvent may be water. Examples of the process of filling the resin in the pores thereof include an immersion process, a spraying process, a brush coating process, and a process in which ferrite particles are impregnated with a resin solution by a coating process such as a fluidized bed process and the solvent is then vaporized.

### Substep 3-2: Coating

The core particles prepared in Step 2 are preferably coated with a coating resin. The resistance of the magnetic carrier can be controlled by adjusting the amount of the coating resin used to coat the core particles.

Even if the pores of the magnetic particles prepared in Substep 3-1 are filled with the resin, the magnetic particles are preferably coated with the coating resin. The resistance of the magnetic carrier can be controlled by adjusting the amount of the coating resin used to coat the magnetic particles. The coating resin may be the same as or different from the resin filled in the pores thereof and may be thermoplastic or thermosetting.

The coating resin may be thermoplastic or thermosetting as described above. When the coating resin is thermosetting, the coating resin can be cured by mixing the coating resin with a curing agent. The coating resin preferably has high releasability.

The coating resin may contain conductive particles or charge-controllable particles.

Examples of the conductive particles include particles of carbon black, magnetite, graphite, zinc oxide, and tin oxide.

The amount of the conductive particles contained in the coating resin is preferably two to 80 parts by mass per 100 parts by mass of the coating resin.

Examples of a component of the charge-controllable particles include organometallic complexes, organometallic salts, chelate compounds, monoazo metal complexes, acetyl acetone metal complexes, hydroxycarboxylic acid metal complexes, polycarboxylic acid metal complexes, polyol metal complexes, polymethyl methacrylate resins, polystyrene resins, melamine resins, phenol resins, nylon resins, silica, titanium oxide, and alumina.

The amount of the charge-controllable particles contained in the coating resin is preferably two to 80 parts by mass per 100 parts by mass of the coating resin.

Examples of a process of coating the core particles with the coating resin include an immersion process, a spraying process, a brush coating process, and a coating process such as a fluidized bed process. In particular, the immersion process is preferred to control the resistance of the magnetic carrier within a desired range.

In order to control the resistance of the magnetic carrier within a desired range, the amount of the coating resin applied to the magnetic particles is preferably 0.1 to 5.0 parts by mass per 100 parts by mass of the magnetic particles.

In order to prevent the injection of a charge into an electrostatic latent image and in order to secure good developability, the magnetic carrier preferably has a dynamic resistivity of 1×10⁷ Ω·cm to 1×10¹² Ω·cm at a field intensity of 1×10⁴ V/cm.

The magnetic carrier according to the present invention has a volume-based 50% (D50) particle size of 15 μm to 100 μm. This allows the ability of the magnetic carrier to frictionally electrify a toner to be improved and also allows the magnetic carrier to be prevented from adhering to a photosensitive member. The 50% (D50) particle size of the magnetic carrier can be adjusted by pneumatic classification or sieve classification.

### Substep 3-3: Separation

The magnetic carrier prepared as described above is preferably screened by classification or sieving whereby coarse particles and fine particles are removed from the magnetic carrier. Furthermore, feebly magnetic particles are preferably removed from the magnetic carrier.

### Measurement of Properties

### Measurement of Dynamic Resistivity

The magnetic carrier is measured for dynamic resistivity at a field intensity of 1×10⁴ V/cm in the form of a magnetic brush by a procedure below.

A developing sleeve of a developing unit containing the magnetic carrier only is placed opposite to a rotational aluminum cylindrical body (hereinafter referred to as aluminum drum) at a predetermined distance. The developing sleeve and the aluminum drum are rotated such that an opposed portion of the developing sleeve and an opposed portion of the aluminum drum move in the same direction. In this state, a direct-current voltage is applied between the developing sleeve and the aluminum drum and the current flowing therebetween is measured, whereby the dynamic resistivity of the magnetic carrier can be determined. In this measurement, the diameter of the aluminum drum is 84 mm and the rotational peripheral speed thereof is 300 mm/s. The developing unit is one used in a copier, imagePRESS C1, available from CANON KABUSHIKI KAISHA. The diameter of the developing sleeve is 25 mm and the rotational peripheral speed thereof is 540 mm/s. The distance between the developing sleeve and the aluminum drum is adjusted to 0.027 cm. The developing unit includes a developer transfer-controlling member which is controlled such that the amount of the magnetic carrier transferred on the developing sleeve is 30 mg/cm².

The contact area between the aluminum drum and a magnetic brush formed by the magnetic carrier is calculated as the product of the longitudinal contact length and circumferential contact length of the aluminum drum. Under conditions of this measurement, the longitudinal contact length and circumferential contact length of the aluminum drum are 32.7 cm and 0.39 cm, respectively, and therefore the contact area therebetween is 12.8 cm².

A direct-current voltage V₀ is applied between the developing sleeve and the aluminum drum (hereinafter referred to as “between S-D”) and the current flowing between S-D is measured, whereby the dynamic resistivity of the magnetic carrier can be determined in the magnetic brush form. A direct-current power supply used is a high-voltage power supply, PZD 2000, available from Trek. The current flowing between S-D is measured with an electrometer, 6517A, available from Keithley after high-frequency noise is reduced with a low-pass filter including a capacitor and a resistor. The dynamic resistivity of the magnetic carrier can be determined by the following equation:

$$Dynamic resistivity = \frac{Vo}{I} \times \frac{S}{d} \qquad ( 1 )$$

wherein V₀ is the voltage applied between S-D, I is the current flowing between S-D, d is the distance between S-D, and S is the contact area between the aluminum drum and the magnetic brush. In this measurement, d=0.027 cm and S=12.8 cm².

The dynamic resistivity of the magnetic carrier is calculated at a field intensity of 1×10⁴ V/cm as described below. The magnetic carrier is measured for dynamic resistivity by varying the voltage V₀ applied thereto and the dynamic resistivity determined by Equation (1) is plotted against the field intensity (V₀/d) formed between S-D, whereby a graph showing the dependence of the dynamic resistivity thereof on an electric field is prepared. From the graph, the dynamic resistivity (Q·cm) thereof is determined at a field intensity V₀/d of 1×10⁴ V/cm. Measurement of volume-based 50% (D50) particle size of pulverized pre-calcined ferrite, perovskite-structured compound powder, and SiO₂ powder

The pulverized pre-calcined ferrite, a powder of the perovskite-structured compound, and a powder of SiO₂ are measured for volume-based 50% (D50) particle size as described below.

The particle size distribution of each powder can be measured with a laser diffraction/scattering particle size distribution analyzer, Microtrac MT 3300EX, available from Nikkiso Co., Ltd.

The pulverized pre-calcined ferrite and a powder of a dielectric material are measured for volume-based 50% (D50) particle size with a wet-type sample circulator, Sample Delivery Control (SDC), available from Nikkiso Co., Ltd. The pre-calcined ferrite (ferrite slurry) is dropwise provided in the sample circulator such that a concentration suitable for measurement is obtained. The flow rate is set to 70%, the ultrasonic wave output power is set to 40 W, and the ultrasonic application time is set to 60 s. Other measurement conditions are as described below.

Set Zero time: 10 s

Measuring time: 30 s

Number of measurements: 10

Refractive index of solvent: 1.33

Refractive index of particles: 2.42

Shape of particles: nonspherical

Measurement upper limit: 1,408 μm

Measurement lower limit: 0.243 μm

Measurement atmosphere: 23° C./50% RH

Measurement of volume-based 50% (D50) particle size of magnetic particle and magnetic carrier

The magnetic particle and the magnetic carrier are measured for volume-based 50% (D50) particle size with a dry-type sample feeder, One-shot Dry-type Sample Conditioner Turbotrac, available from Nikkiso Co., Ltd. A dust collector is used as a vacuum source to supply a sample to the sample feeder at an air flow rate of about 33 L/s and a pressure of about 17 kPa. The sample feeder is automatically controlled by software. The volume-based 50% (D50) particle size is determined from a cumulative volume distribution. Software (Version 10.3.3-202D) supplied with the analyzer is used for control and analysis. Other measurement conditions are as described below.

Set Zero time: 10 s

Measuring time: 10 s

Number of measurements: 1

Refractive index of particles: 1.81

Shape of particles: nonspherical

Measurement upper limit: 1,408 μm

Measurement lower limit: 0.243 μm

Measurement atmosphere: 23° C./50% RH

Measurement of intensity of magnetization of magnetic carrier

The intensity of the magnetization of the magnetic carrier can be measured with a vibration magnetic-field type magnetic-property autographic recorder, BHV-30, available from Riken Denshi Co., Ltd. A measurement procedure is as described below. The magnetic carrier is densely packed in a cylindrical plastic container, an external magnetic field of 79.6 kA/m (1 kOe) is generated, the magnetic moment of the magnetic carrier packed in the container is measured in this state, and the mass of the magnetic carrier packed in the container is then measured, whereby the intensity (Am/kg) of the magnetization of the magnetic carrier is determined.

### EXAMPLES

### Production of Ferrite Particle 1

### Step 1: Preparation of Pulverized Pre-Calcined Ferrite

Substep 1-1: Weighing and mixing

Ferrite raw materials were weighed to obtain the following composition:

Fe₂O₃: 58.6% by mass

MnCO₃: 34.2% by mass

Mg(OH)₂: 5.7% by mass

SrCO₃: 1.5% by mass

The ferrite raw materials were pulverized and mixed for two hours in a dry ball mill with zirconia balls having a diameter of 10 mm.

### Substep 1-2: Pre-Calcination

The mixture was calcined in air at 950° C. for two hours in a burner furnace, whereby a pre-calcined ferrite was prepared.

The pre-calcined ferrite had a composition represented by the formula

(MnO)_{0.385}(MgO)_{0.127}(SrO)_{0.013}(Fe₂O₃)_{0.475}.

### Substep 1-3: Pulverization

The pre-calcined ferrite was crushed with a crusher so as to have a particle size of about 0.3 mm. To 100 parts by mass of the pre-calcined ferrite, 30 parts by mass of water was added. The pre-calcined ferrite was pulverized for one hour in a wet ball mill with stainless balls having a diameter of 10 mm, whereby slurry was obtained.

The slurry was pulverized for one hour in a wet bead mill with zirconia beads having a diameter 1.0 mm and the zirconia beads were then removed from the slurry, whereby Ferrite Slurry A (pulverized calcined ferrite) was obtained.

The pulverized calcined ferrite had a volume-based 50% (D50) particle size of 1.7 μm.

### Step 2: Preparation of Magnetic Particles

### Substep 2-1: Granulation

To 130 parts by mass of Ferrite Slurry A, 30 parts by mass of a SrTiO₃ powder, HPST, having a volume-based 50% (D50) particle size of 1.6 μm, available from Fuji Titanium Industry Co., Ltd. was added, followed by mixing. To 100 parts by mass of the mixture, 2.0 parts by mass of polyvinyl alcohol, serving as a binder, was added. This mixture was granulated into spherical particles with a spray dryer available from Ohkawara Kakohki Co., Ltd.

### Substep 2-2: Calcination

The spherical particles were calcined in an electric furnace with a nitrogen atmosphere having an oxygen concentration of 0.3% by volume in such a manner that the electric furnace was heated to 1,150° C. over four hours and was kept at 1,150° C. for four hours for the purpose of controlling the calcination atmosphere of the spherical particles. After the electric furnace was cooled to room temperature over three hours, porous ferrite particles were taken out of the electric furnace.

### Substep 2-3: Separation

After aggregate particles were broken, the resulting particles were screened through a sieve with 250 μm openings such that coarse particles were removed therefrom. Feebly magnetic particles were removed from the resulting particles with a magnetic separator, whereby Ferrite Particle 1 (magnetic particle) was obtained.

### Production of Ferrite Particle 2

Ferrite Particle 2 was produced in substantially the same manner as that used to produce Ferrite Particle 1 except that the temperature of calcination was increased to 1,050° C. over four hours and was held at 1,050° C. for four hours in Substep 2-2 of producing Ferrite Particle 1.

### Production of Ferrite Particle 3

### Step 1: Preparation of Pulverized Pre-Calcined Ferrite

### Substep 1-1: Weighing and Mixing

Ferrite raw materials were weighed to obtain the following composition:

Fe₂O₃: 69.7% by mass

MnCO₃ and Mg(OH)₂: 1.0% by mass

The ferrite raw materials were pulverized and mixed for two hours in a dry ball mill with zirconia balls having a diameter of 10 mm.

### Substep 1-2: Pre-Calcination

The mixture was calcined in air at 950° C. for two hours in a burner furnace, whereby a pre-calcined ferrite was prepared.

The pre-calcined ferrite had a composition represented by the formula (MnO)_{0.360}(MgO)_{0.024}(Fe₂O₃)_{0.616}.

### Substep 1-3: Pulverization

The pre-calcined ferrite was crushed so as to have a particle size of about 0.3 mm with a crusher. To 100 parts by mass of the pre-calcined ferrite, 30 parts by mass of water was added. The pre-calcined ferrite was pulverized for one hour in a wet ball mill with stainless balls having a diameter of 10 mm.

The slurry was pulverized for one hour in a wet bead mill with zirconia beads having a diameter 1.0 mm and the zirconia beads were then removed from the slurry, whereby Ferrite Slurry B (pulverized calcined ferrite) was obtained.

The pulverized calcined ferrite had a volume-based 50% (D50) particle size of 1.2 μm.

### Step 2: Preparation of Magnetic Particles

### Substep 2-1: Granulation

To 130 parts by mass of Ferrite Slurry B, 30 parts by mass of a SrTiO₃ powder, HPST, having a volume-based 50% (D50) particle size of 1.6 μm, available from Fuji Titanium Industry Co., Ltd. was added, followed by mixing. To 100 parts by mass of the mixture, 2.0 parts by mass of polyvinyl alcohol, serving as a binder, was added. This mixture was granulated into spherical particles with a spray dryer available from Ohkawara Kakohki Co., Ltd.

### Substep 2-2: Calcination

The spherical particles were calcined in an electric furnace with a nitrogen atmosphere having an oxygen concentration of 0.3% by volume in such a manner that the electric furnace was heated to 1,350° C. over five hours and was kept at 1,350° C. for four hours for the purpose of controlling the calcination atmosphere of the spherical particles. After the electric furnace was cooled to room temperature over four hours, ferrite particles were taken out of the electric furnace.

### Substep 2-3: Separation

After aggregate particles were broken, the resulting particles were screened through a sieve with 250 μm openings such that coarse particles were removed therefrom. Feebly magnetic particles were removed from the resulting particles with a magnetic separator, whereby Ferrite Particle 3 was obtained.

### Production of Ferrite Particle 4

Ferrite Particle 4 was produced in substantially the same manner as that used to produce Ferrite Particle 1 except that ten parts by mass of the SrTiO₃ powder was added to 130 parts by mass of Ferrite Slurry A in Substep 2-1 of producing Ferrite Particle 1.

### Production of Ferrite Particle 5

Ferrite Particle 5 was produced in substantially the same manner as that used to produce Ferrite Particle 1 except that a BaTiO₃ powder, BHT-1, having a volume-based 50% (D50) particle size of 1.4 μm, available from Fuji Titanium Industry Co., Ltd. was used instead of the SrTiO₃ powder in Substep 2-1 of producing Ferrite Particle 1.

### Production of Ferrite Particle 6

Ferrite Particle 6 was produced in substantially the same manner as that used to produce Ferrite Particles 1 except that a CaTiO₃ powder, CT, having a volume-based 50% (D50) particle size of 2.1 μm, available from KCM Corporation was used instead of the SrTiO₃ powder in Substep 2-1 of producing Ferrite Particle 1.

### Production of Ferrite Particle 7

Ferrite Particle 7 was produced in substantially the same manner as that used to produce Ferrite Particle 3 except that no SrTiO₃ powder was added to Ferrite Slurry A in Substep 2-1 of producing Ferrite Particle 3.

### Production of Ferrite Particle 8

Ferrite Particle 8 was produced in substantially the same manner as that used to produce Ferrite Particle 3 except that a SiO₂ powder with a volume-based 50% (D50) particle size of 1.8 μm was used instead of the SrTiO₃ powder in Substep 2-1 of producing Ferrite Particle 3.

### Production of Magnetic Material-Dispersed Particle 9

The following powders were weighed and were then mixed together: 100 parts by mass of a magnetite powder with a volume-based 50% (D50) particle size of 0.35 μm and 30 parts by mass of a BaTiO₃ powder with a volume-based 50% (D50) particle size of 1.6 μm. The mixture was lipophilized in such a manner that 4.0 parts by mass of a silane-coupling agent, [3-(2-aminoethyl)aminopropyl]trimethoxysilane, was added to the mixture, followed by high-speed mixing at 100° C. or higher.

The following components were added to 100 parts by mass of the lipophilized mixture, followed by agitation: eight parts by mass of phenol; five parts by mass of a formaldehyde solution containing 40% formaldehyde, 10% methanol, and 50% water; four parts by mass of a 28% aqueous ammonia solution, and eight parts by mass of water. This mixture was heated to 85° C. over 30 minutes while being mixed, was subjected to polymerization for three hours, and was then cured. The reaction mixture was cooled to 30° C. and was then mixed with water. A supernatant liquid was removed from the reaction mixture, whereby precipitates were obtained. The precipitates were water-washed, were air-dried, were further dried at 60° C. in a vacuum, were screened through a sieve with 250 μm openings such that coarse particles were removed, and were then treated with a magnetic separator such that feebly magnetic particles were removed, whereby Magnetic material-dispersed Particle 9 was obtained.

Table 1 summarizes prescriptions of Ferrite Particles 1 to 8 and Magnetic material-dispersed Particle 9 and results obtained by measuring properties (volume-based 50% (D50) particle size, intensity of magnetization, and dynamic resistivity at a field intensity of 1.0×10⁴ V/cm) of Ferrite Particles 1 to 8 and Magnetic material-dispersed Particle 9.

In Table 1, the amount of an added material is expressed in parts by mass per 100 parts by mass of a pre-calcined ferrite or a magnetite. Ferrite Particles 1 to 6 each contain a ferrite and perovskite-structured compound which are sintered and of which phases are combined.

TABLE 1

| | Prescriptions of magnetic particles | | | | Properties of magnetic particles | | |
|---|---|---|---|---|---|---|---|
| | | | Amount of added | | D50 | Intensity of | Dynamic |
| Magnetic | Ferrite | Added | materials | Calcination | particle size | magnetization | resistivity |
| particles | slurries | materials | (parts by mass) | temperatures | (μm) | (Am²/kg) | (Ω · cm) |
| Ferrite | A | SrTiO₃ | 30 | 1,150° C. | 31.8 | 60 | 3.3 × 10⁷ |
| Particle 1 | | | | | | | |
| Ferrite | A | SrTiO₃ | 30 | 1,050° C. | 36.0 | 71 | 5.7 × 10⁷ |
| Particle 2 | | | | | | | |
| Ferrite | B | SrTiO₃ | 30 | 1,350° C. | 47.7 | 68 | 6.2 × 10⁶ |
| Particle 3 | | | | | | | |
| Ferrite | A | SrTiO₃ | 10 | 1,350° C. | 27.3 | 61 | 4.1 × 10⁶ |
| Particle 4 | | | | | | | |
| Ferrite | A | BaTiO₃ | 30 | 1,350° C. | 41.4 | 68 | 1.0 × 10⁸ |
| Particle 5 | | | | | | | |
| Ferrite | A | CaTiO₃ | 30 | 1,350° C. | 33.0 | 59 | 1.4 × 10⁷ |
| Particle 6 | | | | | | | |
| Ferrite | B | Not used | — | 1,350° C. | 35.6 | 59 | 5.4 × 10⁵ |
| Particle 7 | | | | | | | |
| Ferrite | B | SiO₂ | 30 | 1,350° C. | 36.7 | 54 | 7.5 × 10⁹ |
| Particle 8 | | | | | | | |
| Magnetic | — | SrTiO₃ | 30 | — | 35.7 | 50 | 2.1 × 10⁹ |
| material- | | | | | | | |
| dispersed | | | | | | | |
| Particle 9 | | | | | | | |

### Preparation of Resin Solution A

The following components were weighed: 100 parts by mass of a silicone varnish, SR 2410, having a solid content of 20% by mass, available from Dow Corning Toray Co., Ltd.; 97 parts by mass of toluene; and three parts by mass of γ-aminopropyltriethoxysilane. The components were mixed together for one hour in a paint shaker, whereby Resin Solution A was obtained.

### Production of Magnetic Carrier 1

### Substep 3-1: Filling

Into a mixing vessel of a versatile mixer, NDMV, available from Dalton Corporation, 100 parts by mass of Ferrite Particle 1 was charged. Nitrogen gas was introduced into the mixing vessel while the mixing vessel was being evacuated. The mixing vessel was heated to 50° C. and mixing blades in the mixing vessel were rotated at 100 revolutions per minute. Into the mixing vessel, 80 parts by mass of Resin Solution A was charged. Ferrite Particle 1 and Resin Solution A were mixed together. The mixture was heated to 70° C. and was then stirred for two hours under heating such that the solvent was removed from the mixture, whereby pores of Ferrite Particle 1 were filled with a silicone resin composition containing a silicone resin. After being cooled, obtained filled particles were transferred to a drum mixer, UD-AT, available from Sugiyama Heavy Industrial Co., Ltd., including a rotary mixing vessel equipped with spiral blades therein and were then heat-treated at 160° C. for two hours in a nitrogen atmosphere while the rotary mixing vessel was being rotated at two revolutions per minute, whereby magnetic carrier particles were obtained. The magnetic carrier particles were classified through a sieve with 70 μm openings, whereby Magnetic Carrier Core Particles A (filled core) containing 100 parts by mass of Ferrite Particle 1 filled with 8.0 parts by mass of resin were obtained.

### Substep 3-2: Coating

Into a planetary mixer, Nauta Mixer VN, available from Hosokawa Micron Corporation, 100 parts by mass of Magnetic Carrier Core Particles A, which were filled with the silicone resin composition, were charged. Magnetic Carrier Core Particles A were stirred in such a manner that screw-shaped mixing blades of the planetary mixer were revolved at 3.5 revolutions per minute and were rotated at 100 rotations per minute and nitrogen gas was fed at a flow rate of 0.1 m³/minute. In order to remove toluene, the planetary mixer was heated to a temperature of 70° C. at a reduced pressure of about 0.01 MPa. To Magnetic Carrier Core Particles A, one-third of 15 parts by mass of Resin Solution A was added, followed by the removal of toluene and coating for 20 minutes. Another one-third was added to Magnetic Carrier Core Particles A, followed by the removal of toluene and coating for 20 minutes. The other one-third was added to Magnetic Carrier Core Particles A, followed by the removal of toluene and coating for 20 minutes (a coating amount of 1.5 parts by mass). Obtained particles were transferred to a drum mixer, UD-AT, available from Sugiyama Heavy Industrial Co., Ltd., including a rotary mixing vessel equipped with spiral blades therein and were then heat-treated at 160° C. for two hours in a nitrogen atmosphere while the rotary mixing vessel was being rotated at ten revolutions per minute. Particles obtained thereby were classified through a sieve with 70 μm openings and were then treated with a magnetic separator such that feebly magnetic particles were removed therefrom, whereby Magnetic Carrier 1 was obtained.

### Production of Magnetic Carrier 2

Magnetic Carrier 2 was produced in substantially the same manner as that used to produce Magnetic Carrier 1 except that Ferrite Particle 2 was used instead of Ferrite Core 1 and the amount of Resin Solution A used was 16.0 parts by mass.

### Production of Magnetic Carrier 3

Magnetic Carrier 3 was produced in such a manner that Ferrite Particle 3 was subjected only to Substep 3-2 (Coating) of the production of Magnetic Carrier 1.

### Production of Magnetic Carrier 4

Magnetic Carrier Core Particles A prepared in Substep 3-1 of the production of Magnetic Carrier 1 were directly processed into Magnetic Carrier 4.

### Production of Magnetic Carriers 5 to 7

Magnetic Carriers 5 to 7 were produced in substantially the same manner as that used to produce Magnetic Carrier 1 except that Ferrite Particles 4 to 6 were used instead of Ferrite Particle 1.

### Production of Magnetic Carriers 8 and 9

Magnetic Carriers 8 and 9 were produced in substantially the same manner as that used to produce Magnetic Carrier 3 except that Ferrite Particles 7 to 8 were used instead of Ferrite Particle 3.

### Production of Magnetic Carrier 10

Magnetic Carrier 10 was produced by the following procedure: Resin Solution A was applied to Magnetic material-dispersed Particle 9 in a fluidized bed heated to 80° C. such that the amount of a coating resin component was 1.5 parts by mass per 100 parts by mass of Magnetic material-dispersed Particle 9, a solvent was removed from Magnetic material-dispersed Particle 9, Magnetic-dispersed Particle 9 was classified through a sieve with 70 μm openings, and feebly magnetic materials were removed with a magnetic separator.

### Production of Magnetic Carrier 11

To 100 parts by mass of Resin Solution A, one parts by mass of a BaTiO₃ powder with a volume-based 50% (D50) particle size of 1.6 μm was added, followed by mixing, whereby a coating resin solution was prepared. The coating resin solution was applied to Ferrite Particle 7 in a fluidized bed heated to 80° C. such that the amount of a coating resin component was 1.5 parts by mass per 100 parts by mass of Ferrite Particle 7. After a solvent was removed from Ferrite Particle 7, Ferrite Particle 7 was heat-treated at 200° C. for two hours. Ferrite Particle 7 was classified through a sieve with 70 μm openings and feebly magnetic materials were removed with a magnetic separator, whereby Magnetic Carrier 11 was obtained.

Table 2 summarizes prescriptions of Magnetic Carriers 1 to 11 and results obtained by measuring properties (volume-based 50% (D50) particle size, intensity of magnetization, and dynamic resistivity at a field intensity of 1.0×10⁴ V/cm) of Magnetic Carriers 1 to 11.

In Table 2, the amount of a filling resin is expressed in parts by mass per 100 parts by mass of a ferrite core. For Magnetic Carriers 1, 2, and 4 to 7, the amount of a coating resin is expressed in parts by mass per 100 parts by mass of a magnetic carrier particle contained in a ferrite core uncoated with the coating resin or is expressed in parts by mass per 100 parts by mass of a magnetic core. For Magnetic Carriers 3 and 7 to 11, the amount of a coating resin is expressed in parts by mass per 100 parts by mass of each magnetic core.

TABLE 2

| | | Prescriptions of filling resin and coating resin | | | Properties of magnetic carriers | | |
|---|---|---|---|---|---|---|---|
| | | Amount of | | Amount of | D50 | Intensity of | Dynamic |
| | Magnetic | filling resin | Coating | coating resin | particle size | magnetization | resistivity |
| | particles | (parts by mass) | resin | (parts by mass) | (μm) | (Am²/kg) | (Ω · cm) |
| Magnetic | Ferrite | 8.0 | Resin | 1.5 | 32.3 | 55 | 7.2 × 10⁹ |
| Carrier 1 | Particle 1 | | Solution A | | | | |
| Magnetic | Ferrite | 16.0 | Resin | 1.5 | 36.9 | 60 | 3.1 × 10⁹ |
| Carrier 2 | Particle 2 | | Solution A | | | | |
| Magnetic | Ferrite | Not used | Resin | 1.5 | 48.0 | 67 | 1.6 × 10⁹ |
| Carrier 3 | Particle 3 | | Solution A | | | | |
| Magnetic | Ferrite | 8.0 | Not used | Not used | 32.0 | 55 | 4.6 × 10⁸ |
| Carrier 4 | Particle 1 | | | | | | |
| Magnetic | Ferrite | 8.0 | Resin | 1.5 | 27.6 | 51 | 5.2 × 10⁹ |
| Carrier 5 | Particle 4 | | Solution A | | | | |
| Magnetic | Ferrite | 8.0 | Resin | 1.5 | 42.1 | 61 | 2.1 × 10¹⁰ |
| Carrier 6 | Particle 5 | | Solution A | | | | |
| Magnetic | Ferrite | 8.0 | Resin | 1.5 | 33.3 | 52 | 9.7 × 10⁹ |
| Carrier 7 | Particle 6 | | Solution A | | | | |
| Magnetic | Ferrite | Not used | Resin | 1.5 | 35.8 | 59 | 2.3 × 10⁷ |
| Carrier 8 | Particle 7 | | Solution A | | | | |
| Magnetic | Ferrite | Not used | Resin | 1.5 | 37.0 | 53 | 6.8 × 10¹⁰ |
| Carrier 9 | Particle 8 | | Solution A | | | | |
| Magnetic | Magnetic | — | Resin | 1.5 | 35.8 | 50 | 4.4 × 10⁹ |
| Carrier 10 | material- | | Solution A | | | | |
| | dispersed | | | | | | |
| | Particle 9 | | | | | | |
| Magnetic | Ferrite | Not used | Resin | 1.5 | 36.2 | 59 | 3.1 × 10⁹ |
| Carrier 11 | Particle 7 | | Solution A | | | | |
| | | | and BaTiO₃ | | | | |

### Production of Cyan Toner

Production of Resin

The following materials were selected to obtain a vinyl copolymer unit and were placed in a dripping funnel: ten parts by mass of styrene, five parts by mass of 2-ethylhexyl acrylate, two parts by mass of fumaric acid, five parts by mass of an α-methyl styrene dimer, and five parts by mass of dicumyl peroxide. The following materials were selected to obtain a polyester polymer unit and were placed in a 4-liter four-necked glass flask: 25 parts by mass of polyoxypropylene(2.2)-2,2-bis(4-hydroxyphenyl)propane, 15 parts by mass of polyoxyethylene(2.2)-2,2-bis(4-hydroxyphenyl)propane, nine parts by mass of terephthalic acid, five parts by mass of trimellitic anhydride, 24 parts by mass of fumaric acid, and 0.2 part by mass of tin 2-ethylhexanoate. A thermometer, a stirrer, a condenser, and a nitrogen-introducing tube were attached to the four-necked flask. The four-necked flask was placed in a mantle heater. After the air in the four-necked flask was replaced with nitrogen gas, the four-necked flask was gradually heated while the materials therein were being stirred. The materials in the dripping funnel were added dropwise into the four-necked flask over about four hours at 130° C. under stirring. The four-necked flask was heated to 200° C. and the mixture therein was subjected to reaction for four hours, whereby Hybrid Resin A having a weight-average molecular weight of 78,000, a number-average molecular weight of 3,800, and a glass transition temperature of 62° C. was obtained.

Production of Cyan Masterbatch

The following materials were charged into a kneader mixer and were then heated without pressurization while being mixed: 60.0 parts by mass of Hybrid Resin A and 40.0 parts by mass of a cyan pigment (C. I. Pigment Blue 15:3). After the mixture was heated to a temperature of 90° C. to 110° C. and was melt-kneaded for 30 minutes, the resulting mixture was cooled and was then pulverized in a pin mill so as to have a particle size of about 1 mm, whereby a cyan masterbatch was prepared.

Production of Cyan Toner

The following materials were preliminarily mixed together in a Henschel mixer: 100.0 parts by mass of Hybrid Resin A, 5.5 parts by mass of purified paraffin wax with a maximum endothermic peak of 70° C., 25.5 parts by mass of a cyan masterbatch containing 40% by mass of a coloring agent, and 1.0 parts by mass of an Aluminum compound of di-tert-butylsalicylic acid. The mixture was melt-kneaded with a twin-screw kneading extruder with a preset outlet temperature of 120° C. such that the temperature of the kneaded mixture was 150° C. After being cooled, the kneaded mixture was roughly pulverized in a hammer mill so as to have a particle size of about 1 to 2 mm. The resulting mixture was roughly pulverized in a hammer mill which included a hammer difference in shape from one included in that hammer mill and which had a smaller mesh, whereby a roughly pulverized product with a particle size of about 0.3 mm was prepared. The roughly pulverized product was moderately pulverized in a turbo mill, including an RS rotor and an SNB liner, available from Turbo Kogyo Co., Ltd., whereby a moderately pulverized product with a particle size of about 11 μm was prepared. The moderately pulverized product was further pulverized in a turbo mill, including an RSS rotor and an SNNB liner, available from Turbo Kogyo Co., Ltd. so as to have a particle size of about 6 μm and was finely pulverized in the turbo mill including the RSS rotor and the SNNB liner, whereby a finely pulverized product with a particle size of about 5 μm was prepared. The finely pulverized product was subjected to classification using a particle design apparatus, Faculty, available from Hosokawa Micron Corporation, whereby cyan toner particles having a weight-average size (D4) of 5.8 μm were obtained.

The following materials were added to 100 parts by mass of the obtained cyan toner particles: 1.0 part by mass of silica particles, treated with hexamethyldisilazane, having a number-average particle size of 110 nm and hydrophobicity of 85%; 0.9 part by mass of titanium oxide particles having a number-average particle size of 50 nm and a hydrophobicity of 68%; and 0.5 part by mass of silica particles, treated with dimethyl silicone oil, having an number-average particle size of 20 nm and a hydrophobicity of 90%. The mixture was stirred in a Henschel mixer available from Mitsui Miike Kako Co., Ltd., whereby a cyan toner having a weight average particle size of 5.8 μm was obtained.

### Example 1

In a V-type mixer, 90 parts by mass of Magnetic Carrier 1 and ten parts by mass of the cyan toner were shaken, whereby Two-component Developer A corresponding to an initial development state was prepared. Two-component Developer A was sealed in a developing unit used in a copier, imagePRESS C1, available from CANON KABUSHIKI KAISHA. A screw placed in the developing unit was operated at idle for a time corresponding to the printing of 20,000 sheets, whereby Two-component Developer B corresponding to a developer subjected to a 20,000-copies durability test at low coverage rate was obtained.

Images were formed with a modified Canon imagePRESS C1 copier in a normal-temperature, normal-humidity environment having a temperature of 23° C. and a relative humidity of 50% in such a manner that Two-component Developer A or B was placed in a developing unit located at a black position. A transfer material used was CLC paper (81.4 g/cm²) available from CANON KABUSHIKI KAISHA. The obtained images were evaluated for density, graininess, and white spot by methods below. The evaluation results are summarized in Table 3.

(1) Image Density

The images were evaluated for density as described below. Charge and exposure conditions were set by controlling the charge and exposure of a photosensitive drum used such that the difference between the potential VL (which was −150 V in this example) of a maximum-density image portion and the potential VD (which was −550 V in this example) of a non-image portion was 400 V. The surface potential of the photosensitive drum was measured with a surface electrometer, MODEL 347, available from Trek Inc. in such a manner that the surface electrometer was placed directly under a developing region where a developing sleeve and the photosensitive drum were arranged opposite to each other. The direct-current voltage Vdc of the developing bias voltage was set such that the development contrast Vcon (=|Vdc−VL|) was 250 V and the back contrast Vback (=|VD−Vdc|) was 150 V. Under these conditions, solid images were output. The obtained solid images were evaluated for density on the basis of the transmission density Dt of each solid image. In this embodiment, the transmission density Dt thereof was measure with a transmission densitometer, TD 904, available from Macbeth in a red filter mode. Standards for evaluating image density were as described below.

A: a transmission density Dt of 1.55 or more

B: a transmission density Dt of 1.50 to less than 1.55

C: a transmission density Dt of 1.45 to less than 1.50

B: a transmission density Dt of less than 1.45

(2) Graininess

Evaluation for graininess was performed by a method below.

As described on the measurement of transmission density, charge and exposure conditions were set such that the difference between the potential VL (which was −150 V in this example) of a maximum-density image portion and the potential VD (which was −550 V in this example) of a non-image portion was 400 V. The direct-current voltage Vdc of the developing bias voltage was set such that the development contrast Vcon (=|Vdc−VL|) was 250 V and the back contrast Vback (=|VD−Vdc|) was 150 V. Subsequently, a digital latent image with a 16-step gradation was formed on the photosensitive drum, was developed, was transferred, and was then fixed, whereby an image with a 16-step gradation was obtained. The obtained image had a lightness L* of 75. The graininess GS of the obtained image was calculated by a method below.

For the measurement of the granularity of silver halide photographs, RMS granularity up is usually used. Conditions for the measurement of granularity are specified in ANSI PJ-2. 40-1985 “root mean square (rms) granularity of film”.

A technique using the power spectrum (Wiener spectrum) of density fluctuation is used herein to measure graininess. In the technique, a value obtained by cascading and then integrating the Wiener spectrum and visual transfer function (VTF) of an image is defined as graininess (GS). A higher GS value means that the image has undesired graininess. For details, see R. P. Dooley and R. Shaw, Noise Perception in Electrophotography, J. Appl. Photogr. Eng. 5(4).

A detailed procedure for measurement is as follows: an 800-dpi image is sampled from an image output on a sheet of paper with a scanner, CanoScan 9950F, available from CANON KABUSHIKI KAISHA; the sampled image is divided into pieces with 512×512 pixels; each piece is converted into a frequency domain by two-dimensional Fourier transform (FT); a Wiener spectrum is determined by the sum of the squares of the real and imaginary parts of the frequency domain; and the Wiener spectrum is multiplied by VTF and is then integrated, whereby the graininess GS is obtained. In this example, the graininess was digitalized using VTF at an observation distance of 60 cm as proposed by Dooley by the following equation:

GS=exp(−1.8 D̅)∫\sqrt{WS(u)}·VTF(u)du (2)

wherein u is a spatial frequency, WS(u) is a Wiener spectrum, VTF (u) is a visual transfer function, and the term exp(−1.8 D̅) is a function in which D* appears as a parameter, D̅ being an average density for compensating the difference between the density and lightness sensed by a human.

Standards for evaluating graininess were as described below.

A: a graininess GS of less than 0.170

B: a graininess GS of 0.170 to less than 0.180

C: a graininess GS of 0.180 to less than 0.190

D: a graininess GS of 0.190 or more

(3) Measurement of White Spots

The term “white spot” specified herein as a problem means a phenomenon in which a halftone region of an image has white dots, the halftone region being located on the low-density side of a edge region in which a high-density region and low-density region of the image are adjacent to each other and which is perpendicular to the feed direction of a sheet of transfer paper. The “white spot index” used herein as an evaluation index is determined by digitizing the area of the white dots of the halftone region.

A detailed technique for determining the white spot index is described below. A chart is output on a sheet of transfer paper so as to have halftone transverse zones (30H, a width of 10 mm) and solid black transverse zones (FFH, a width of 10 mm) arranged in the feed direction of the transfer paper sheet (that is, an image is formed in such a manner that a halftone zone with a width of 10 mm is formed over a lengthwise portion of a photosensitive member, a solid black zone with a width of 10 mm is formed over another lengthwise portion thereof, and this procedure is repeated). The output chart is read with a scanner and an image obtained by scanning the chart is averaged in the feed direction of the transfer paper sheet, whereby a one-dimensional brightness distribution with a 256-step gradation is obtained. A value (the area of a hatched region shown in the FIGURE) obtained by integrating the difference in brightness between the density level of a halftone image and the density level of a white spotted region of an edge section is defined as a white spot index. In this example, a readout scanner used was a Kodak EverSmart Supreme II scanner and a chart was read with the scanner at a resolution of 4,800 dpi in such a mode that the readout range was from a minimum density of 0.08 to a maximum density of 1.60 and gamma was linear to lightness. The density was measured with a spectrodensitometer, X-Rite 530, available from X-Rite in a status-A mode.

Standards for evaluating white spots were as described below.

A: a white spot index of less than 100

B: a white spot index of 100 to less than 200

C: a white spot index of 200 to less than 300

D: a white spot index of greater than 300

### Examples 2 to 7 and Comparative Examples 1 to 4

Two-component developers were prepared in substantially the same manner as that described in Example 1 except that Magnetic Carriers 2 to 7 were used in combination with the cyan toner. The two-component developers were used to form images, which were evaluated for properties such as (1) density, (2) graininess, and (3) white spot index. The evaluation results are summarized in Table 3.

TABLE 3

| | | Image properties | | | | | |
|---|---|---|---|---|---|---|---|
| | | | | | Two-component Developer B | | |
| | | Two-component Developer A | | | (corresponding to one subjected to | | |
| | | (corresponding to fresh one) | | | 20,000-copies durability test) | | |
| | Magnetic | Transmission | | White spot | Transmission | | White spot |
| | carriers | density Dt | Graininess | index | density Dt | Graininess | index |
| Example 1 | Magnetic | 1.56 (A) | 0.143 (A) | 88 (A) | 1.52 (B) | 0.171 (B) | 156 (B) |
| | Carrier 1 | | | | | | |
| Example 2 | Magnetic | 1.55 (A) | 0.151 (A) | 94 (A) | 1.50 (B) | 0.177 (B) | 189 (B) |
| | Carrier 2 | | | | | | |
| Example 3 | Magnetic | 1.54 (B) | 0.154 (A) | 126 (B) | 1.48 (C) | 0.182 (C) | 211 (C) |
| | Carrier 3 | | | | | | |
| Example 4 | Magnetic | 1.59 (A) | 0.176 (B) | 78 (A) | 1.55 (A) | 0.188 (C) | 145 (B) |
| | Carrier 4 | | | | | | |
| Example 5 | Magnetic | 1.54 (B) | 0.146 (A) | 163 (B) | 1.46 (C) | 0.173 (B) | 230 (C) |
| | Carrier 5 | | | | | | |
| Example 6 | Magnetic | 1.57 (A) | 0.149 (A) | 85 (A) | 1.53 (B) | 0.178 (B) | 166 (B) |
| | Carrier 6 | | | | | | |
| Example 7 | Magnetic | 1.55 (A) | 0.154 (A) | 80 (A) | 1.51 (B) | 0.184 (C) | 143 (B) |
| | Carrier 7 | | | | | | |
| Comparative | Magnetic | 1.48 (C) | 0.191 (C) | 415 (D) | 1.41 (D) | 0.230 (D) | 730 (D) |
| Example 1 | Carrier 8 | | | | | | |
| Comparative | Magnetic | 1.46 (C) | 0.146 (A) | 520 (D) | 1.36 (D) | 0.174 (B) | 920 (D) |
| Example 2 | Carrier 9 | | | | | | |
| Comparative | Magnetic | 1.51 (B) | 0.150 (A) | 262 (C) | 1.46 (C) | 0.179 (B) | 455 (D) |
| Example 3 | Carrier 10 | | | | | | |
| Comparative | Magnetic | 1.51 (B) | 0.153 (A) | 229 (C) | 1.47 (C) | 0.191 (D) | 362 (D) |
| Example 4 | Carrier 11 | | | | | | |

The evaluation results summarized in Table 3 show that the two-component developers containing Magnetic Carriers 1 to 7, which correspond to a magnetic carrier according to the present invention, can be used to stably output high-quality images having sufficient density, few white spots, and excellent graininess over a long period of time.

For Magnetic Carriers 1 to 3, ferrite core particles contained in Magnetic Carrier 1 have the greatest pore volume and those contained in Magnetic Carrier 3 have the least pore volume, because calcination conditions were adjusted in the step of producing each ferrite core. This shows that the resistance and magnetic properties of a magnetic carrier can be controlled in such a manner that the pore volume of ferrite core particles is adjusted by adjusting calcination conditions.

Although Magnetic Carriers 1 and 4 both contain Ferrite Core 1, Magnetic Carrier 1 is coated with resin but Magnetic Carrier 4 is not coated with resin. This shows that the resistance and magnetic properties of a magnetic carrier can be controlled by adjusting the amount of resin applied to a ferrite core.

Magnetic Carriers 1 and 5 are different in the ratio of a ferrite to perovskite-structured compound used in the step of producing a ferrite core. This shows that the resistance and magnetic properties of a magnetic carrier can be controlled.

As described above, the resistance and magnetic properties of a magnetic carrier according to the present invention can be controlled by adjusting conditions for producing the magnetic carrier and therefore the magnetic carrier can be used to output an image having an excellent white spot index and excellent graininess over a long period of time.

Although a perovskite-structured compound contained in a magnetic core contained in Magnetic Carrier 1, 6, or 7 is SrTiO₃, BaTiO₃, or CaTiO₃, respectively, Magnetic Carriers 1, 6, and 7 have substantially the same effect. Magnetic Carrier 8 contains a magnetic core containing no perovskite-structured compound and Magnetic Carrier 9 contains a magnetic core containing SiO₂, which has no perovskite structure. Magnetic Carriers 8 and 9 provide images which have an allowable level of density in a newly printed state and which, however, have white spots. Magnetic Carriers 8 and 9 subjected to a durability test have reduced developability ad reduced image density. This is probably due to a reason below. When a magnetic core contains a perovskite-structured compound with a high dielectric constant, a magnetic carrier containing the magnetic core has an increased dielectric constant. An electric field formed around a magnetic brush during development has substantially increased intensity due to the polarization effect of the magnetic carrier. This probably leads to an improvement in developability to result in an improvement in white spot.

Magnetic Carrier 10 in a fresh state can be used to output an image having relatively high quality although the image is slightly inferior to those obtained using Magnetic Carriers 1 to 7. An image formed using Magnetic Carrier 10 subjected to a durability test has white spots. This is probably because Magnetic Carrier 10 is a magnet-dispersed resin carrier containing a magnetic core containing BaTiO₃ coated with a binder resin with a low dielectric constant and therefore has insufficient developability. On the other hand, a magnetic carrier according to the present invention contains ferrite phases and perovskite-structured compound-containing phases combined with each other. Since interfaces between the ferrite phases and the perovskite-structured compound-containing phases function as electrodes, the magnetic carrier can more efficiently exhibit a polarization effect as compared to such a magnet-dispersed resin carrier and therefore can be used to output an image having sufficient density, few white spots, and excellent graininess over a long period of time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-256236 filed Nov. 9, 2009, which is hereby incorporated by reference herein in its entirety.

What is claimed is:

1. A magnetic carrier containing magnetic carrier particles each of which has at least a magnetic particle and resin,
wherein the magnetic particle contains ferrite phases and phases comprising a perovskite-structured compound, and wherein the ferrite phases and the phases comprising perovskite-structured compound are combined.

2. The magnetic carrier according to claim 1, wherein the perovskite-structured compound is selected from the group consisting of barium titanate, strontium titanate, and calcium titanate.

3. The magnetic carrier according to claim 1, wherein the magnetic particle has pores.

4. The magnetic carrier according to claim 3, wherein the pores are filled with resin.

5. The magnetic carrier according to claim 1, wherein the magnetic particle is coated with resin.
